(19) United States
(12) Patent Application Publication
(10) Pub. No.: US 2026/0195754 A1
(43) Pub. Date: Jul. 9, 2026

(54) BIOMETRIC IDENTITY AUTHENTICATION

(71) Applicant: MASTERCARD INTERNATIONAL INCORPORATED, Purchase, NY (US)

(72) Inventors: Ameya Vinayak Sohoni, Pune (IN); Kaushal Shetty, O’Fallon, MO (US); Mayank Joshi, Pune (IN)

(21) Appl. No.: 19/011,151

(22) Filed: Jan. 6, 2025

(51) Int. Cl. G06Q 20/40; G06Q 20/38

(52) U.S. Cl. CPC G06Q 20/40145; G06Q 20/3825; G06Q 20/4016

(57) ABSTRACT

Systems and methods for biometric identity authentication can include receiving, at an application server, a first authentication request from an application at a first device, wherein the first authentication request includes an authentication token requesting access to a particular account at the application server and a first user identity string associated with a first user, wherein the authentication token includes confirmation that a biometric credential was validated by the first device; validating, at the application server, the authentication token; determining, at the application server, that the first user identity string corresponds to the particular account; and based on the validity of the authentication token and that the first user identity string corresponds to the particular account, returning a signal of success for the first authentication request to the application to allow access to the particular account at the application at the first device.

### BACKGROUND

Biometric authentication is a trusted and safe authentication mechanism. Biometric data is typically stored in secure and trusted data elements of a device and not shared outside of the mobile device at which it is stored. Instead, a certification of success that biometric authentication has been confirmed is shared to an application utilizing biometric authentication.

While the current methods of biometric authentication are considered to be very secure, conventional biometric authentication does not require a validation of identity. Indeed, when a single device is configured with multiple biometric data records of the same type (e.g., face identification) for several different users (e.g., User 1, User 2, and User 3), any one of the biometric credentials associated with any one of the registered biometric data records, when presented, would return an authentication result as a success, thus allowing any of the registered users to successfully authenticate at the device and/or application.

However, there may be certain instances where it would be useful to distinguish between users attempting biometric authentication based on the unique identity of the user. Therefore, there is a need for a process to validate user identity during biometric authentication.

### BRIEF SUMMARY

Systems and techniques for biometric identity authentication to enable validation of user identity during authentication at an application are described. As described herein, during biometric identity authentication, when a user requests access to a particular account at an application on a device, the authentication request sent to the application server includes both an authentication token and a user identity string. Advantageously, in addition to validating the authentication token, the application server confirms an identity of the requesting access to the particular account using the user identity string. Indeed, the application server can confirm whether the user identity string included in the authentication request corresponds to the particular account before permitting access to the particular account.

In some aspects, the techniques described herein relate to a method, including: receiving, at an application server, a first authentication request from an application at a first device, wherein the first authentication request includes an authentication token requesting access to a particular account at the application server and a first user identity string associated with a first user, wherein the authentication token includes confirmation that a biometric credential was validated by the first device; validating, at the application server, the authentication token; determining, at the application server, that the first user identity string corresponds to the particular account; based on the validity of the authentication token and that the first user identity string corresponds to the particular account, returning a signal of success for the first authentication request to the application to allow access to the particular account at the application at the first device; receiving, at the application server, a second authentication request from the application at the first device, wherein the second authentication request includes the authentication token requesting access to the particular account at the application server and a second user identity string associated with a second user; validating, at the application server, the authentication token received with the second authentication request; determining, at the application server, that the second user identity string does not correspond to the particular account; and based on the determination that the second user identity string does not correspond to the particular account, returning a signal of failure for the second authentication request to the application to deny access to the particular account at the application at the first device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment for example authentication scenarios.

FIG. 2A illustrates an example process for enrollment of a biometric credential for biometric authentication at a device.

FIG. 2B illustrates an example process of local biometric authentication at a device.

FIG. 3A illustrates an example process of conventional authentication at an application.

FIG. 3B illustrates an example process for enrollment for conventional biometric authentication at an application.

FIG. 3C illustrates an example process of conventional biometric authentication at an application.

FIG. 3D illustrates a plurality of graphical user interfaces (GUIs) corresponding to an example scenario for accessing an application requiring authentication credentials.

FIG. 4 illustrates an operating environment for biometric identity authentication.

FIG. 5 illustrates an example process for enrollment for biometric identity authentication at an application.

FIG. 6A illustrates an example process of biometric identity authentication at an application.

FIG. 6B illustrates an example graphical user interface for a result of success for biometric identity authentication at an application.

FIG. 6C illustrates an example graphical user interface for a result of failure for biometric identity authentication at an application.

FIG. 6D illustrates an example graphical user interface for a result of success for biometric identity authentication for a particular profile at an application.

FIGS. 7A-7C illustrate example implementations of a process of validating an authentication request during biometric identity authentication.

FIG. 8 illustrates an example process for registration at a biometric service provider.

FIGS. 9A and 9B illustrate example implementations of computing systems that may be used in certain embodiments described herein.

### DETAILED DESCRIPTION

Systems and techniques for biometric identity authentication to enable validation of user identity during authentication at an application are described. As described herein, during biometric identity authentication, when a user requests access to a particular account at an application on a device, the authentication request sent to the application server includes both an authentication token and a user identity string. Advantageously, in addition to validating the authentication token, the application server confirms an identity of the requesting access to the particular account using the user identity string. Indeed, the application server can confirm whether the user identity string included in the authentication request corresponds to the particular account before permitting access to the particular account.

“Biometric authentication” refers to a process of verifying an individual based on unique biological characteristics (e.g., biometric credentials).

A “biometric credential” refers to a measurable biological (anatomical and physiological) or behavioral characteristic that can be used for automated recognition. A biometric credential can include a fingerprint, scan of face, hand, and/or eyes (e.g., iris, retina, etc.) or any other biometric credential used to identify an individual.

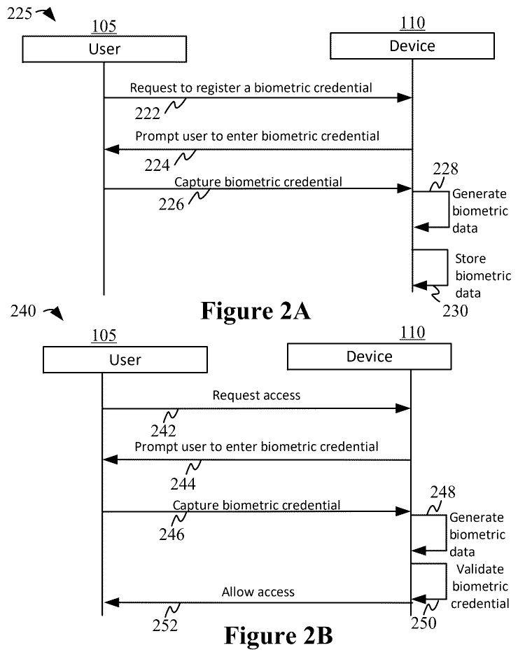

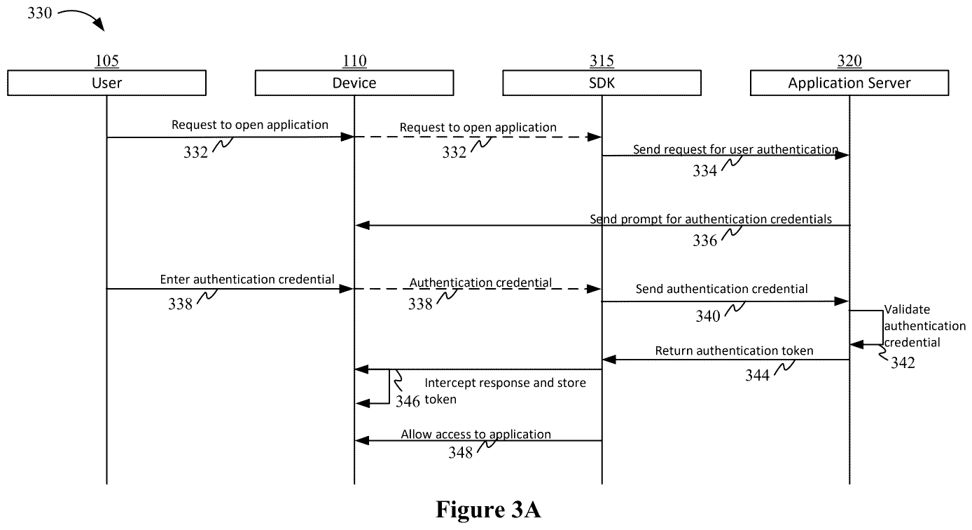

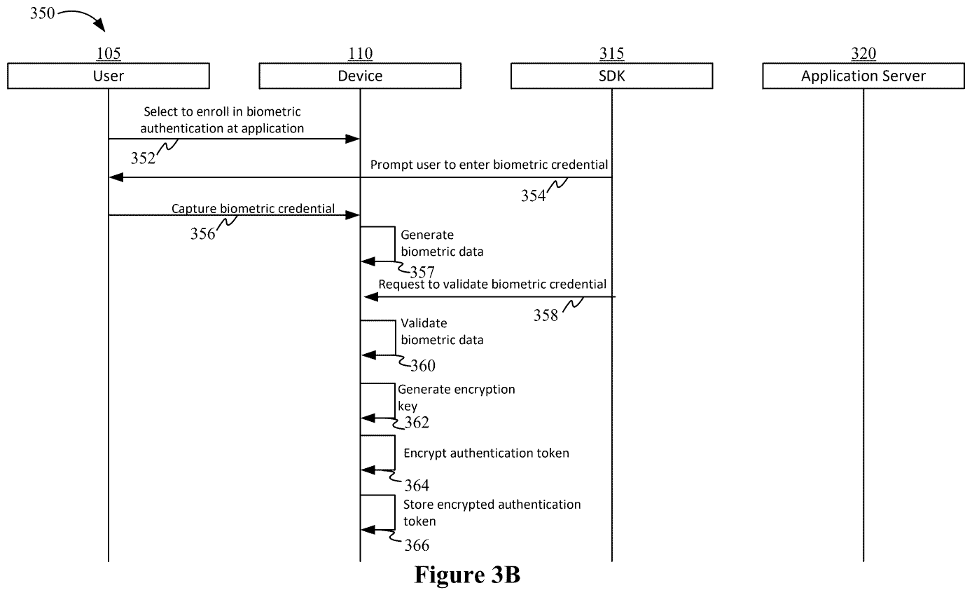

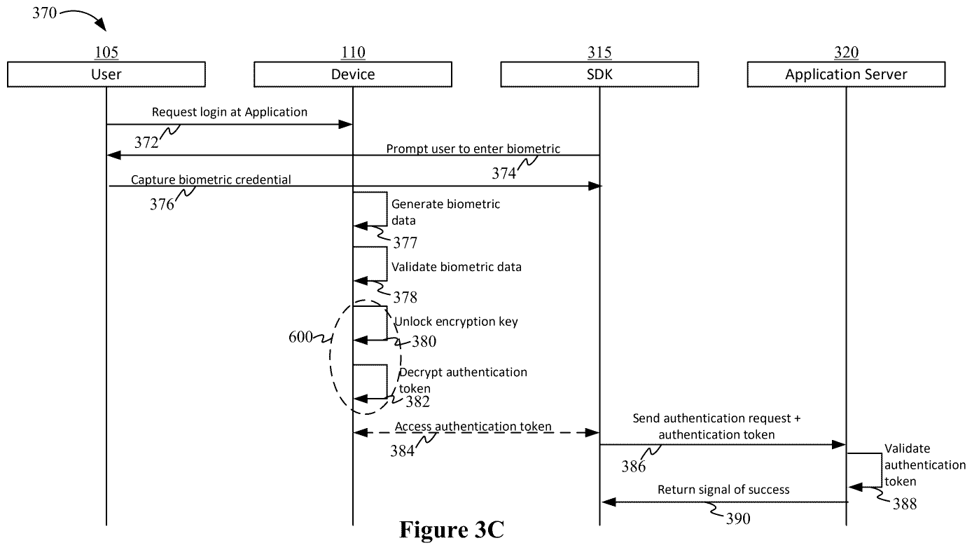

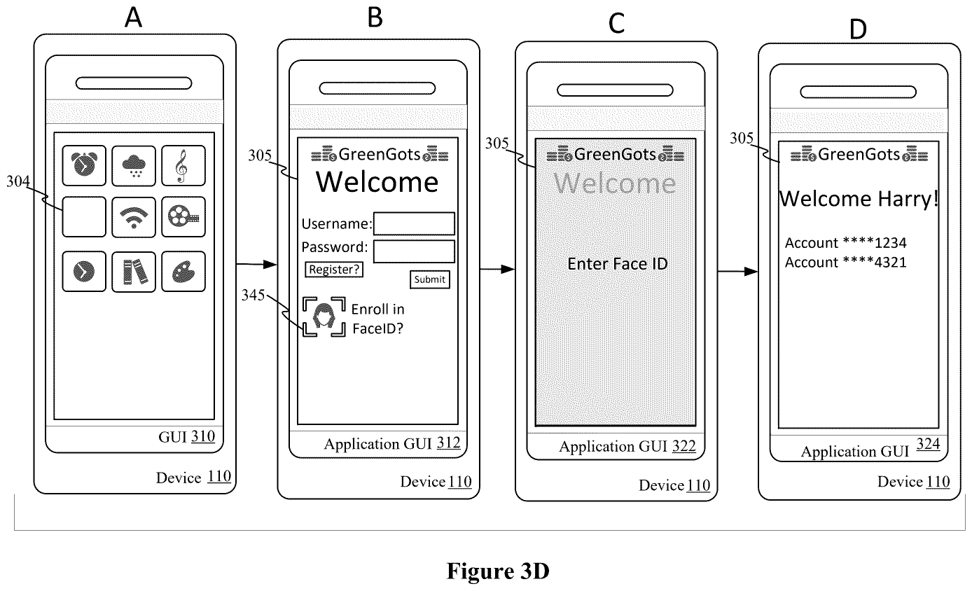

Conventionally, biometric authentication methods (e.g., process 240 described with respect to FIG. 2B and process 370 described with respect to FIG. 3C) provide for stronger security than conventional authentication methods (e.g., process 330 described with respect to FIG. 3A).

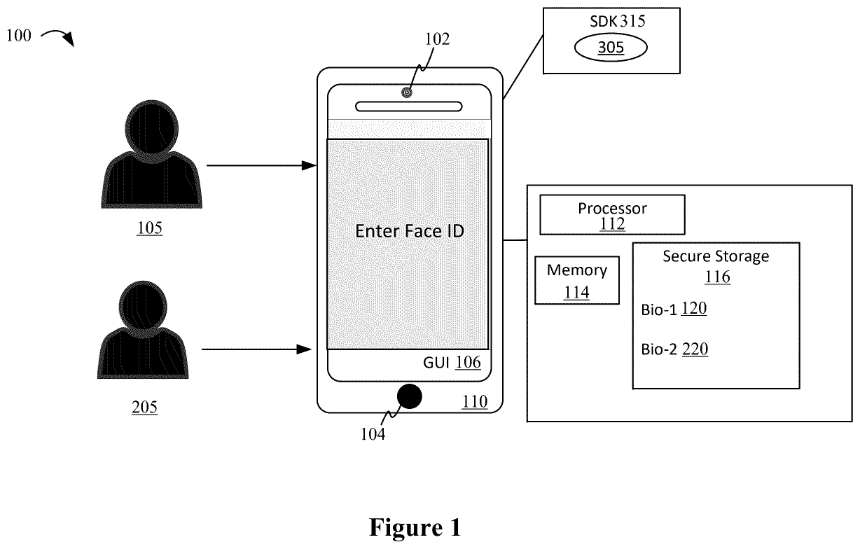

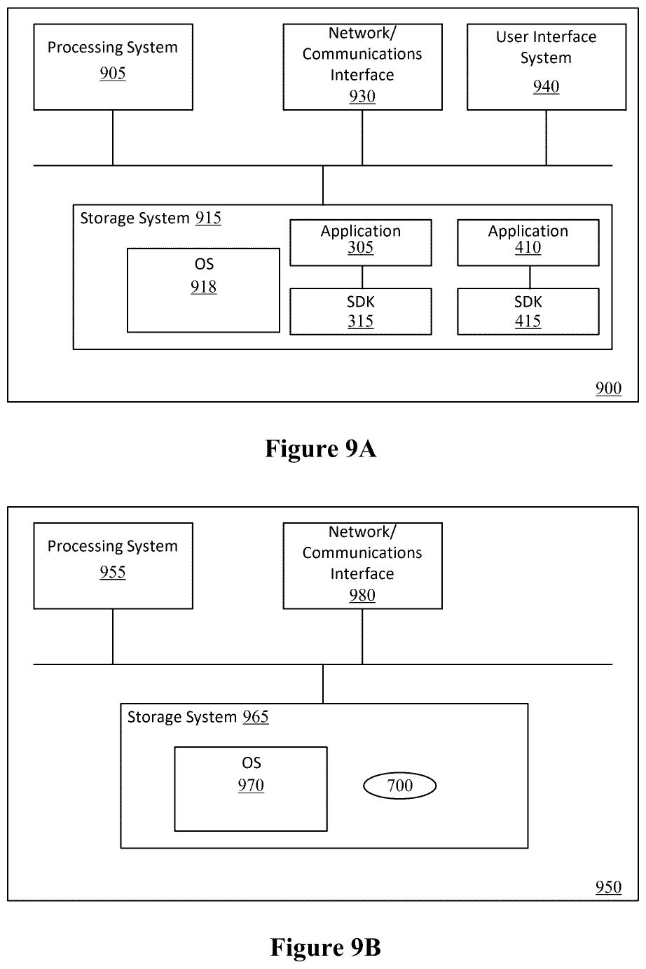

FIG. 1 illustrates an operating environment for example authentication scenarios. Referring to FIG. 1, the operating environment 100 can include a user 105, a second user 205, and a device 110. The device 110 can include a camera 102 and/or a fingerprint scanner 104, a processor 112, a memory 114, and a secure storage 116. The device 110 can support applications (e.g., application 305 and application 410) and their associated software development kits (SDKs) (e.g., SDK 315 and SDK 415). Examples of the device 110 can include, but are not limited to, a mobile device, a computing device, a tablet, or a gaming device. The device 110 can be embodied as system 900 described with respect to FIG. 9A.

FIG. 2A illustrates an example process for enrollment of a biometric credential for biometric authentication at a device. In biometric authentication, a user 105 can present a biometric credential that can be used to perform the biometric authentication. The user 105 can register a first biometric credential (e.g., face scan of user 105) at device 110, for example via process 225 described with respect to FIG. 2A.

Referring to FIG. 1 and FIG. 2A, a process 225 for enrollment of a biometric credential for biometric authentication at the device 110 can begin when the user 105 requests (222) to register a biometric credential at the device 110.

In response, the device 110 can prompt (224) the user 105 to enter a biometric credential, as shown at graphical user interface (GUI) 106. The device 110 can capture (226) a biometric credential entered by the user 105 at the device 110. In some cases, capturing (226) the biometric credential at the device 110 can include capturing, via the camera 102, a plurality of images, scans, and/or samples of the biometric credential (e.g., face, eyes, etc.). In some cases, capturing (226) the biometric credential at the device 110 can include capturing a plurality of images, scans, and/or samples of the biometric credential (e.g., fingerprint) via the fingerprint scanner 104.

The device 110 can generate (228) biometric data corresponding to the biometric credential of the user 105 captured (226) by the device 110. In some cases, the biometric data is a digital format of the biometric credential sample captured (226) by the device 110.

In some cases, biometric data can include a biometric template created of the biometric credential. A biometric template is a digital representation of biometric data. In order to create a biometric template, the source data (e.g., data of the biometric credential) is collected by a sensor (e.g., camera 102, fingerprint scanner 104, etc.). The captured biometric data of the biometric credential can be analyzed through various algorithms and mathematical models to convert the biometric data into a biometric template. This biometric template can become a master profile from which the unique features of the user's biometric credential are extracted, analyzed, and then converted into a mathematical file. In some cases, the biometric template can be pseudonymized.

The device 110 can store (230) the biometric data as a biometric data record (e.g., first biometric data record “Bio-1” 120) at the secure storage 116 at the device 110. The secure storage 116 can include secure control and logic circuitry. The secure storage 116 can be a Trusted Execution Environment (TEE). A TEE can be a protected area of a device's (e.g., device 110) main processor that keeps data and code safe from the rest of the system. A TEE is a segregated area of memory and CPU that is protected from the rest of the CPU using encryption. In some cases, the biometric data can be generated (118) at the secure storage or other TEE of the device 110.

The secure storage 116 can store a plurality of biometric data records enrolled (e.g., via process 225) for a plurality of biometric credentials. For example, as shown in FIG. 1, the secure storage 116 can store a first biometric data record “Bio-1” 120 for the face biometric credentials of user 105 and can store a second biometric data record “Bio-2” 220 for the face biometric credential of second user 205. Indeed, in many cases, any user with biometric data stored at the secure storage 116 can successfully pass biometric authentication attempts at the device 110 by presenting the corresponding biometric credential, regardless of the identity of the user.

For example, as described with more detail with respect to FIG. 2B, because the secure storage 116 is storing both first biometric data record “Bio-1” 120 and second biometric data record “Bio-2” 220,” during an authentication attempt to access the device 110, presenting either the first biometric credential associated with “Bio-1” 220 or the second biometric credential associated “Bio-2” 220 will successfully gain access to the device since the result of the biometric authentication process is a certificate of success that there is a match, not who corresponds to the match.

FIG. 2B illustrates an example process of local biometric authentication at a device. Referring to FIG. 1 and FIG. 2B, process 240 can begin when a user 105 requests (242) access at a device 110 (e.g., request to unlock device). The device 110 can prompt (244) the user 105 to enter the biometric credential, as shown in GUI 106. The device 110 can capture (246) the biometric credential entered by the user 105 at the device 110. In some cases, capturing (246) the biometric credential at the device 110 can include capturing, via the camera 102, one or more scans of the user's 105 face. In some cases, capturing (246) the biometric credential at the device 110 can include capturing, via the fingerprint scanner 104, one or more scans of the user's 105 finger.

In response to capturing (246) the biometric credential of the user 105, the device 110 can generate (248) biometric data corresponding to the biometric credential of the user 105 captured (246) by the device 110.

Then, the device 110 can validate (250) the generated biometric data of the captured biometric credential.

In some cases, validating (250) the generated biometric data of the captured biometric credential can include comparing the generated biometric data of the captured biometric credential to the biometric data records stored at the secure storage 116. To validate (250) the generated biometric data of the captured biometric credential, the device 110 can determine whether the biometric data of the captured biometric credential and any of the biometric data records stored at secure storage 116 are sufficiently similar to be the same person.

If the device 110 determines that there is a biometric data record stored at the secure storage 116 that is sufficiently similar to the generated biometric data of the captured biometric credential of the user 105 captured (246) by the device 110, an indication of success is obtained and the device 110 can allow (252) access to the device 110 (e.g., unlock the device). In some cases, if the device 110 determines that there is no enrolled biometric data record stored at the secure storage 116 that is sufficiently similar to the biometric data of the captured biometric credential of the user 105 captured (246) by the device 110, the device 110 can deny access to the device 110.

In the example process described with respect to FIG. 1 and FIG. 2B, both user 105 and second user 205 would be able to successfully access device 110 via process 240 because the secure storage 116 has stored a biometric data record associated with both user 105 (e.g., first biometric data record “Bio-1” 120) and second user 205 (e.g., second biometric data record “Bio-2” 220).

However, if a third user (not shown) presented a biometric credential, the device 110 may determine that there is no biometric data record stored at the secure storage 116 that is sufficiently similar to the biometric data of the captured biometric credential third user, and the device 110 would therefore deny access to the third user.

In addition to using biometric authentication to gain access to a device, in some cases, once a user 105 has enrolled for biometric authentication at a device 110, the user 105 can opt to enroll for biometric authentication for applications (e.g., mobile applications, web applications, etc.) that support biometric authentication, for example, as via process 330 described with respect to FIG. 3A. In some cases, the user 105 can enroll in biometric authentication for the application and enroll their biometric credential at the device 110 simultaneously.

In many cases, prior to enrolling in biometric authentication at an application, the user must first perform conventional authentication (e.g., using username/password) to log in to a particular account at the instance of the application executing at the device 110.

FIG. 3A illustrates an example process of conventional authentication at an application. FIG. 3D illustrates a plurality of graphical user interfaces (GUIs) corresponding to an example scenario for accessing an application requiring authentication credentials.

Referring to FIG. 1, FIG. 3A and FIG. 3D, process 330 of performing conventional authentication at an application 305 can begin when a user 105 requests (332) to open an application 305 at a device 110, for example, by selecting the application shortcut 304 at GUI 310 on device 110 as shown in FIG. 3D.

An application 305 can be a computer software package that performs a specific function directly for an end user (e.g., user 105), or in some cases, for another application. An application 305 can be self-contained or a group of programs. The programs are a set of operations that runs the application 305 for the user 105. In some cases, application 305 can include a user front end that enables interaction by a user to certain functionality of the application which may be hosted remotely from the user front end (e.g., in a client-server or web application configuration).

The application 305 can include a software development kit 315. A software development kit (SDK) 315 can be a collection of software development tools in an installable package. The SDK tools allow an application developer to build an application (e.g., application 305) which can integrate with another program (e.g., operating system of device 110). The SDK 315 can be integrated into the application 305 by a developer. In some cases, the code of the SDK 315 can be added to the application 305 directly. In some cases, SDKs (e.g., SDK 315) are required for developing a platform-specific application, for example, for iOS applications, the iOS SDK is required.

Once the device 110 receives the user 105 request (332) to open the application 305, the device 110, for example via the SDK 315 of the application 305, can send (334) a request for user authentication to an application server 320.

An application server (e.g., application server 320) can host an application (e.g., application 305) that is accessible through a web browser or other application front end at a device (e.g., device 110). The application server 320 can execute processes enabling the service provided by application 305.

In response to receiving the request for user authentication, the application server 320 can send (336) a prompt for authentication credentials to the application 305 at the device 110, as shown in application GUI 312. Examples of authentication credentials can include a password (and username) or a personal identification number (PIN). In some cases, the user 105 is registered with the application server 320. In some cases, the user 105 can register with the application server 320 (e.g., by selecting the option to register, as shown in application GUI 312).

The user 105 can enter (338) authentication credentials, for example, at application GUI 312 of device 110. The SDK 315 can send (340) the authentication credential entered (338) by the user 105 to the application server 320 for authentication. The application server 320 can validate (342) the received authentication credential. Validating (342) the authentication credential can include querying a database or other storage mechanism storing valid credentials to validate the presence and authenticity of credentials provided by the user 105.

In response to validating (342) the authentication credential, if the authentication credential provided by the user 105 is valid, the application server 320 can return (344) an authentication token.

The authentication token is a unique access token associated with the application 305. During the life of the token, the user 105 can access the application 305 the token has been issued for, rather than having to re-enter credentials each time they go back to the same application 305. The authentication token can include information associated with a particular account of the user (e.g., username, account information, etc.). Authentication tokens can work like a stamped ticket, allowing the user 105 to retain access to the application 305 as long as the authentication token remains valid. In some cases, once the user 105 logs out or quits the application 305, the authentication token is invalidated.

The device 110, via the SDK 315, can intercept (346) the authentication response and store the authentication token in memory 114 or in secure storage 116.

Additionally, once the SDK 315 receives the authentication token, the SDK 315 can allow (348) access to the application 305, for example, as shown in application GUI 324 of FIG. 3D.

On subsequent access attempts, a user (e.g., user 105 or second user 205) can gain access to the application 305 by repeating process 330, provided that the user can input the correct authentication credential.

However, while conventional authentication described with respect to FIG. 3A provides some security benefit, because the authentication credential must be provided to gain access, biometric authentication is a more secure and convenient alternative to using traditional authentication credentials (e.g., passwords or PINs).

Therefore, many applications (e.g., application 305) biometric authentication. For example, user 105 can opt to enroll in biometric authentication at an application via process 350 as described with respect to FIG. 3B.

FIG. 3B illustrates an example process for enrollment for conventional biometric authentication at an application.

Referring to FIG. 1, FIG. 3B, and FIG. 3D, a user 105 can opt to enroll in biometric authentication at the application 305 via process 350.

For example, the user 105 can select (352) to enroll in biometric authentication for the application 305 at the device 110 by selecting the “enroll in FaceID?” option 345 displayed at application GUI 312 as shown in FIG. 3D before or after entering their authentication credentials. The notification of enrollment can be sent to the application server 320 and the enrollment for conventional biometric authentication is able to continue after the device receives an authentication token (e.g., returned 344 by the application server 320 if the authentication credential provided by the user 105 is valid).

In some cases, the SDK 315 can prompt (354) the user 105 to enter a biometric credential. In some cases, the biometric credential has been enrolled at the device 110 (e.g., via process 225 as described with respect to FIG. 2A).

When biometric data of the biometric credential is entered by the user 105, the device 110 can capture (356) the biometric credential entered by the user 105; and generate (357) biometric data of the biometric credential entered by the user 105. The SDK 315 can send (358) a request to validate the generated biometric data of the biometric credential to the device 110 and the device 110 can validate (360) the generated biometric data of the captured biometric credential. In some cases, validating (360) the generated biometric data of the captured biometric credential can include comparing the generated biometric data of the captured biometric credential to the biometric data stored at the secure storage 116. To validate (360) the captured biometric credential, the device 110 can determine whether the biometric data of the captured biometric credential and any of the biometric data records stored at the secure storage 116 are sufficiently similar to be the same person.

In some cases, if there is no enrolled biometric data record of the captured biometric credential stored at the secure storage 116, the SDK 315 can request that the user 105 enroll a biometric credential at the device (e.g., via process 225 as described with respect to FIG. 2A). In some cases, the validation of the biometric data is omitted (e.g., operations 356, 357, 358 and 360) and enrollment can use a different authentication process (e.g., use of authentication credentials) or directly move to next step.

To continue enrollment, the device 110 can generate (362) an encryption key, for example, through a seed value obtained after validation 360 of the user's biometric data. In some cases, the encryption key is a symmetric encryption key and in some cases the encryption key is an asymmetric encryption key. In some cases, the device 110 can store the encryption key at the secure storage 116.

Once the device 110 generates (362) the encryption key, the device 110 can encrypt (364) the authentication token stored at the device 110 (e.g., at memory 114 or at secure storage 116) and store (366) the encrypted authentication token at secure storage 116. The authentication token can be the authentication token received from the application server 320 and stored at the device 110 via process 330 described with respect to FIG. 3A.

Once the user 105 has enrolled a biometric credential at the application 305, the device 110 and the SDK 315 can perform biometric authentication for subsequent authentication attempts at the application 305, for example, in process 370 as described with respect to FIG. 3C.

FIG. 3C illustrates an example process of conventional biometric authentication at an application. Referring to FIG. 1 and FIGS. 3C-3D, process 370 can begin when a user 105 requests (372) to log in to an application 305 that has been enrolled in biometric authentication (e.g., via process 350 as described with respect to FIG. 3B.) For example, the user's 105 request (372) to log in to the application 305 can be triggered by selecting the application shortcut 304 at GUI 310 on device 110 or by selecting to log in at the application 305 (not shown).

The SDK 315 can prompt (374) the user 105 to enter a biometric credential, for example, as shown at application GUI 322 of FIG. 3D. The device 110 can capture (376) a biometric credential entered by the user 105.

Once the device 110 captures (376) the biometric credential, the device 110 can generate (377) biometric data of the biometric credential entered by the user 105.

Then, the device 110 can validate (378) the generated biometric data of the biometric credential. In some cases, validating (378) the biometric credential can include comparing the generated biometric data of the captured biometric credential to the biometric data stored at the secure storage 116. To validate (378) the captured biometric credential, the device 110 can determine whether the generated biometric data of the captured biometric credential and any of the biometric data records stored at the secure storage 116 are sufficiently similar to be the same person.

Notably, even though user 105 was the one who initiated and facilitated process 350 to enroll in biometric authentication at application 305, both user 105 and second user 205 could present biometric credentials that would result in successful validation at step (378). The device 110 is not validating an identity of either user. The device 110 is only validating whether the generated biometric data of the captured biometric credential and any of the biometric data records stored at the secure storage 116 are sufficiently similar to be the same person. Since both user 105 and second user 205 have biometric data records stored at secure storage (e.g., first biometric data record “Bio-1” 120 or second biometric data record “Bio-2” 220), presentation of biometric credentials of either user results in successful validation.

If the device 110 determines that there is biometric data that matches the biometric credential of the user 105, the device 110 can unlock (380) the encryption key stored at the secure storage 116 and decrypt (382) the authentication token stored at the secure storage 116 using the encryption key.

The SDK 315 can access (384) the authentication token stored by the device 110. Then, the SDK 315 can send (386) an authentication request including the authentication token to the application server 320 for validation. The authentication token can include an indicator that a biometric credential entered at the device 110 was validated by the device 110.

The application server 320 can validate (388) the authentication token included in the authentication request. In some cases, validating (388) the authentication token can include determining whether the authentication token includes an indicator that the biometric credential entered at the device 110 was validated by the device 110.

In some cases, where the authentication token is valid, the application server 320 can return (390) a signal of success and the SDK 315 can allow access to the application 305, for example, as illustrated in application GUI 324 illustrated at FIG. 3D.

In some cases, where the authentication token is invalid, the application server 320 can return a signal of failure and the SDK 315 can deny access to the application 305.

In some cases, as a variation of process 370 for FIDO biometric authentication, when the device 110 generates (362) the encryption key, the device 110 generates asymmetric encryption keys (e.g., public and private) and stores the asymmetric encryption keys at secure storage 116. The device 110 (e.g., via SDK 315) can share the public key with the application server 320, against which a “nonce” or “random-string” is challenged by the application server 320. Then, after generating (362) the encryption keys, the SDK 315 can again prompt the user 105 to provide the biometric credential, where validation of the biometric credential unlocks the private key from secure storage 116 and the private key can be used to sign the “nonce” or “random-string,” which is then sent to the application server 320. Then, the application server 320 can validate the signed “nonce” or “random-string” using the public key shared by the device 110. If successful, the application server 320 can grant authentication and respond back with a session token, which can be stored inside secure storage 116.

While biometric authentication provides for stronger security than conventional authentication (e.g., via process 330 described with respect to FIG. 3A), using conventional biometric authentication processes, the application server 320 is unable to distinguish between users attempting access to a particular application from the same device 110. Rather, the application sever makes the validation determination based solely on information included in the authentication token provided in the authentication request.

Indeed, neither the device 110 nor the application server 320 are able to distinguish between a login attempt made by user 105 and a login attempt made by second user 205, where both users have biometric data records stored at the secure storage 116 of the device 110. In other words, conventional biometric authentication (either at the device 110 via process 240 or at an application 305 via process 370) does not include validation of a particular user's identity, only validation that a biometric data record associated with biometric data of a biometric credential is stored at the device 110.

For example, referring to FIGS. 1, 2A, 2B, and 3A-3C, consider an illustrative scenario where both a parent (e.g., user 105) and child (e.g., second user 205) have stored their biometric credentials at the secure storage 116 of device 110 (e.g., via process 225 for enrollment in biometric authentication at a device). As shown in FIG. 1, the secure storage 116 of device 110 has stored a first biometric data record “Bio-1” 120 associated with user 105 and a second biometric data record “Bio-2” 220 associated with the second user 205.

In this illustrative scenario, via the example process 240 of local biometric authentication at a device 110, both the parent (e.g., user 105) (by entering the first biometric credential) and the child (e.g., second user 205) (by entering the second biometric credential) would be able to successfully pass biometric authentication at the device 110 (e.g., unlock the device), because both the first biometric data record “Bio-1” 120 and the second biometric data record “Bio-2” 220 are stored at the secure storage 116.

Next, consider the example process 330 of conventional authentication at an application 305. In this scenario, via process 330, the parent (e.g., user 105) can log in to the application 305 using a known authentication credential associated with a particular account (e.g., username/password). In this case, for the child (e.g., second user 205) to be able to log in to the particular account at the application 305, the child would also need to know/have access to the username and password to log in at the application 305. However, once known, anyone with the username and password can access the application 305.

Now, consider the example process 370 of conventional biometric authentication at an application 305. Unlike in the process 330 of conventional authentication, which uses the authentication credential (e.g., username/password), the process 370 of conventional biometric authentication at the application 305 requires that the party attempting to access the application 305 has a biometric data record of the biometric credential enrolled at the device 110 (e.g., via process 225 for enrollment in biometric authentication at a device).

However, even if the parent (e.g., user 105) used a particular biometric credential to enroll for biometric authentication at the application 305 (e.g., via the example process 370), on subsequent log in attempts, any user with a biometric data record for their biometric credential stored at the secure storage 116 of the device 110 can access the application 305 via process 370.

Once a user's biometric credential is enrolled at the secure storage 116 of the device 110, there is nothing preventing that user from accessing a particular application (e.g., application 305) on that device 110 that has been enrolled in biometric authentication-even if said user is not the account holder for the particular application.

For example, the user 105 (e.g., a parent) may have a biometric credential of the second user 205 (e.g., child) enrolled at the device 110 for ease of access to the device 110 for the second user 205. Additionally, the user 105 may wish to enroll themselves in biometric authentication at application 305 (e.g., a banking application) for ease of access to the application for the user 105. However, because the application 305 may be of a particularly sensitive nature, like a banking application, the user 105 may not wish for the second user 205 to be able to access the application 305.

Unfortunately, current biometric authentication for an application 305 does not also validate a user's identity in addition to validating that a biometric data record matches the captured biometric credential being stored by the device 110.

Advantageously, the biometric identity authentication process described herein enforces validation of an authentication request not just based on whether a biometric credential has been successfully validated by the device 110, but additionally based on identity of the individual providing the biometric credential that resulted in the successfully validation at the device 110.

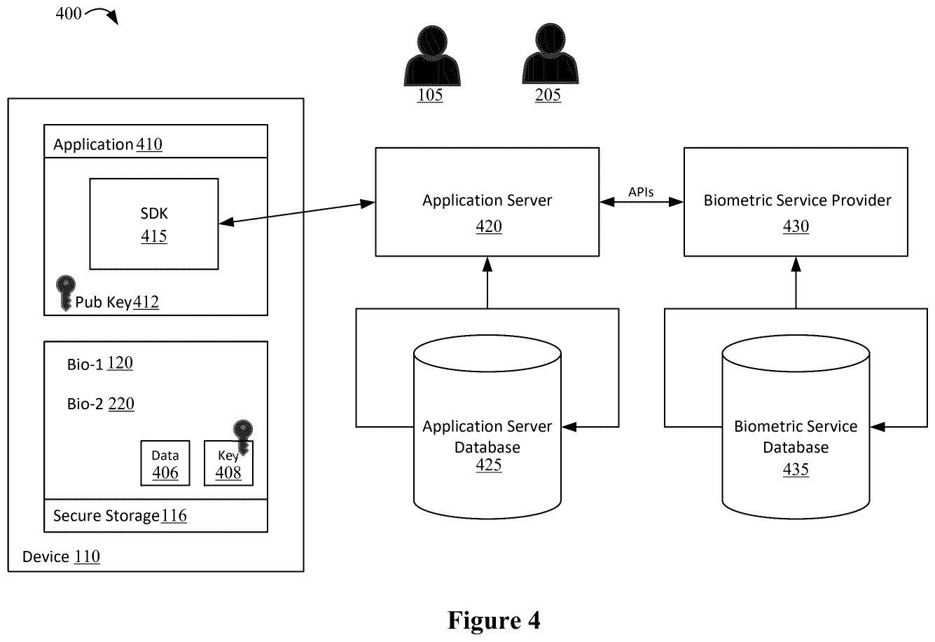

FIG. 4 illustrates an operating environment for biometric identity authentication. The operating environment 400 can include user 105, second user 205, device 110, secure storage 116, an application 410, an SDK 415, an application server 420, an application server database 425, a biometric service provider 430, and a biometric service database 435. First biometric data record “Bio-1” 120 and the second biometric data record “Bio-2” 220 can be stored as described with respect to FIGS. 1 and 2A. Authentication token(s) for application 410 can be stored encrypted using key 408. For example, the device 110 can generate an encryption key (e.g., key 408), encrypt the authentication token (e.g., stored at data 406 in secure storage 116), encrypt the authentication token, and store the encrypted authentication token (e.g., in a similar manner as described with respect to process 350 of FIG. 3B).

The application server 420 for the application 410 (and associated SDK 415) can support biometric identity authentication at application 410. Biometric identity authentication validates that a user identity associated with a biometric data record corresponds to an identity of a particular user who is authorized to access a particular account registered at the application server 420.

The application server 420 can utilize the biometric service provider 430 to provide a biometric identity authentication at an instance of their application (e.g., application 410). In some cases, the application server 320 utilizes the biometric service provider 430 using APIs.

A biometric service provider 430 is a service provider that securely stores biometric data against identity data. For example, in some cases, the biometric service provider 430 is a government institution. In some cases, the biometric service provider 430 is a service provider that provides identity verification products, for example, identity verification by allowing individuals to provide proof of their legal identity online. Biometric service provider 430 can provide the appropriate biometric services from computing systems maintained by or used by biometric service provider 430.

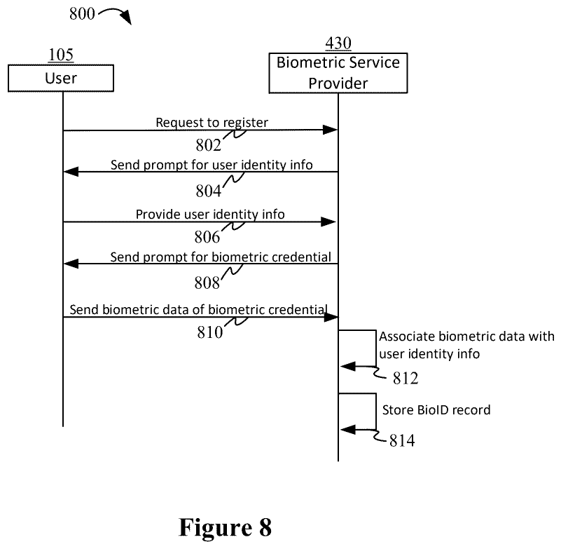

As described in more detail with respect to FIG. 8, the user 105 can register a biometric credential (e.g., face scan, fingerprint, etc.) with a biometric service provider 430. Once a user 105 registers with the biometric service provider 430, the biometric service provider 430 can generate and store a biometric identity (BioID) record including both the user's 105 biometric data against the user's 405 identity data (e.g., demographic data), which can be used to uniquely and accurately identify a user based on received biometric data.

Once the user 105 has enrolled a biometric credential at the device 110 (e.g., via process 225 described with respect to FIG. 2A) and has registered the same biometric credential at the biometric service provider 430 (e.g., via process 800 described with respect to FIG. 8), the user 105 can enroll in biometric identity authentication for application 410.

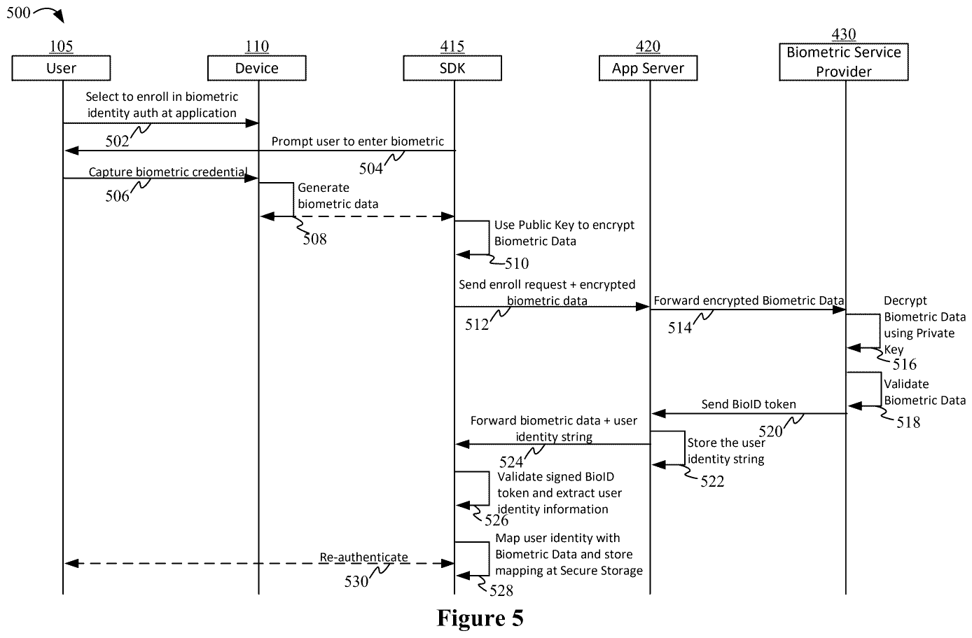

FIG. 5 illustrates an example process for enrollment for biometric identity authentication at an application.

Referring to FIG. 4 and FIG. 5, the user 105 can opt to enroll in biometric identity authentication at the application 410 via process 500. In some cases, the user 105 has already logged into the application 410 (e.g., via process 330 described with respect to FIG. 3A). Indeed, the data 406 of the secure storage 116 can include the authentication token received from an application server and stored at the device 110 during conventional authentication (e.g., via process 330).

The user 105 can select (502) to enroll in biometric identity authentication for the application at the device 110. The SDK 415 can prompt (504) the user 105 to enter a biometric credential. In some cases, the biometric credential has been enrolled at the device 110 (e.g., via process 225 as described with respect to FIG. 2A). For example, the first biometric data record “Bio-1” 402 stored at the secure storage 116 can correspond to biometric credential of the user's 105 face.

The device 110 can then capture (506) the biometric credential (e.g., face scan) entered by the user 105. In response to capturing (506) the biometric credential, the device 110 can generate (508) biometric data of the captured biometric credential.

The SDK 415 can access the generated biometric data. The SDK 415 can use a pre-configured public key 412 to encrypt (510) the biometric data of the user 105. In some cases, the SDK 415 can include a pre-configured public key 412 provided by the biometric service provider 430 (e.g., via the application server 420).

Notably, during the process 500 of enrollment in biometric identity authentication, the biometric data is encrypted. Unlike the conventional enrollment in biometric authentication at an application (e.g., via process 350 described with respect to FIG. 3B), the biometric data is not only being stored locally on the device 110. In process 500 of enrollment in biometric identity authentication, the biometric data is sent to the application server 420. Since the biometric data will be leaving the device 110, the biometric data is encrypted before it leaves the device 110 (e.g., for security reasons).

Once the biometric data has been encrypted, the SDK 415 can send (512) a request to enroll the particular account in biometric identity authentication at the application 410 to the application server 420. The request can include the encrypted biometric data corresponding to a biometric credential of the user 105. The application server 420 can forward (514) the encrypted biometric data to the biometric service provider 430 for user identity validation.

When the biometric service provider 430 receives the encrypted biometric data from the application server 420, the biometric service provider 430 can decrypt (516) the biometric data using a private key (corresponding to the public key 412).

Because the biometric service provider 430 stores BioID records that includes both a user's biometric data and a user's identity data, the biometric service provider 430 can validate (518) the identity of the user 105 based on the decrypted biometric data. In some cases, validating (518) the decrypted biometric data can include querying the biometric service database 435 for a BioID record that includes biometric data that the biometric service provider 430 determines is likely to correspond to the decrypted biometric data.

If the biometric service provider 430 identifies a matching BioID record, the biometric service provider 430 can send (520) a BioID token including a user identity string associated with the user 105 to the application server 420. The user identity string is a unique string of characters uniquely identifying the user 105. For example, the user identity string for user 105 can be “123ABC”.

The BioID token can include data of the matching BioID record stored at the biometric service database 435 (e.g., user identity string associated with the user 105). In some cases, the BioID token is signed using a private key at the biometric service provider 430. In some cases, the BioID token is a JSON Web Token (JWT) signed using a private key.

In some cases, the BioID token includes a user identity information (e.g., first name of the particular user and a last name of the particular user) and a user identity string corresponding to the particular user. For example, the BioID token for user 105 may include “Jane Doe” and “123ABC.”

The application server 420 receives the BioID token including the user identity information and the user identity string associated with the user 105 and stores (524) the user identity string of the BioID token at the application server database 425. In some cases, the application server 420 can store (462) the user identity string against a particular account (e.g., user's 105 account) at the application server database 425 (e.g., the user profile logged into at the application 410 at the device via process 330 described with respect to FIG. 3A.

The application server 420 can forward (522) the BioID token to the SDK 415. Once the SDK 415 receives the BioID token, the SDK 415 can validate (526) the BioID token using the public key 412 and extract the user identity string associated with the user 105.

Then, the device 110 (and/or the SDK 415) can map (528) the user identity string to the biometric data record stored on the device 110 (e.g., at secure storage 116) and store the identity string on the device 110 (e.g., at secure storage 116). For example, the data 406 at the secure storage 116 can include a mapping of the user identity string associated with user 105 against the first biometric data record “Bio-1” 120.

In some cases, the SDK 415, can prompt (530) reauthentication of the user 105 to confirm user 105 presence.

In some cases, instead of encrypting (510) the biometric data to send the encrypted biometric data to the application server 420, and subsequently to the biometric service provider 430 for validation, generation of user identity string, and biometric/identity mapping, a local biometric service can be on device 110 which directs performance of the validation of user identity on the device 110. The device 110 can create the user identity string, which is then mapped (528) and send to the application server 420 (not shown).

Once the user 105 has enrolled in biometric identity authentication at an application 410, the user 105 can use their biometric credential for subsequent login attempts.

Advantageously, unlike the conventional biometric authentication methods (e.g., process 240 described with respect to FIG. 2B or via process 370 described with respect to FIG. 3C), because biometric identity authentication includes confirmation of user identity, only user 105 will be able to log in to the application 410 during biometric identity authentication.

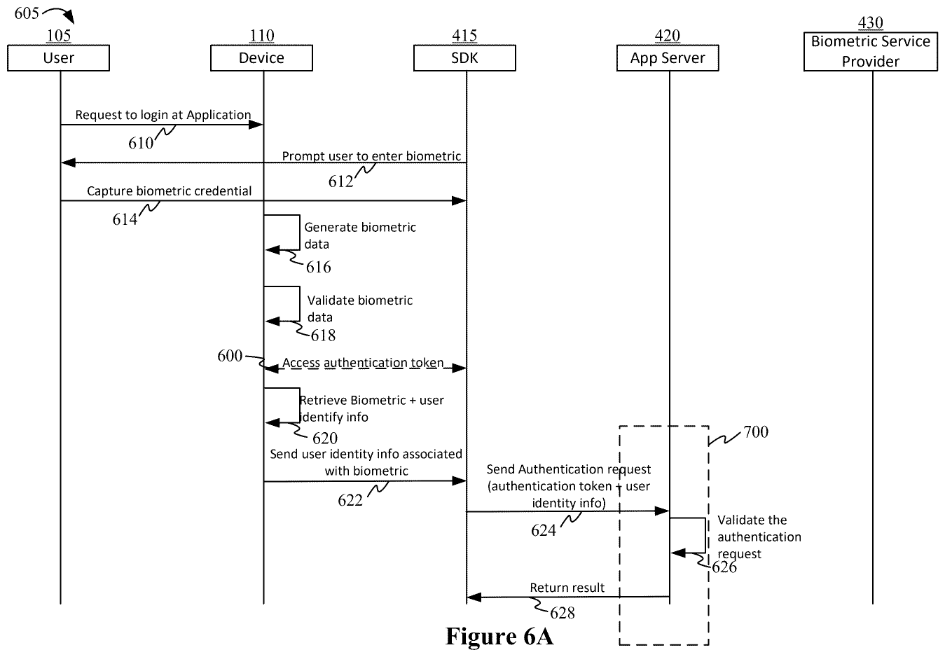

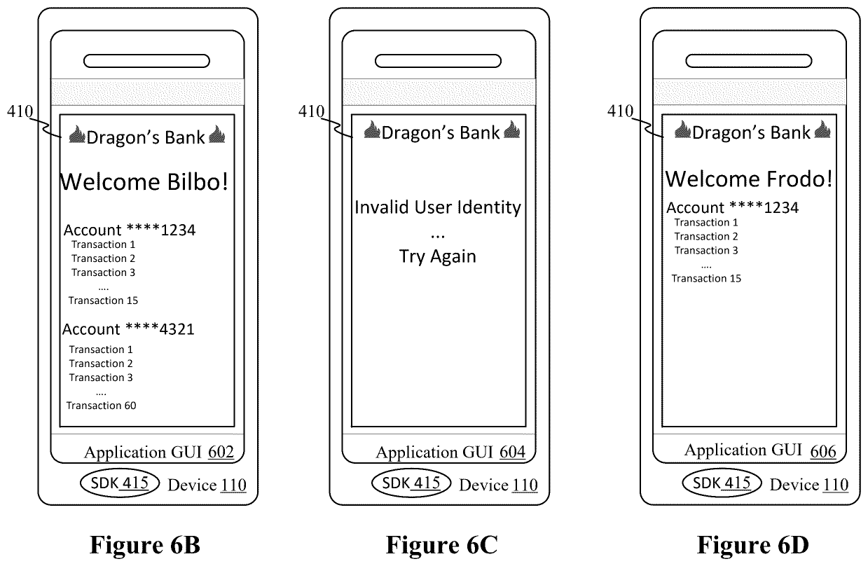

FIG. 6A illustrates an example process of biometric identity authentication at an application.

Referring to FIG. 4 and FIG. 6A, process 605 can begin when user 105 requests (610) to log in to an application 410. Notably, the user 105 has already enrolled a biometric credential for biometric identity authentication at that application 410 (e.g., via process 500 as described with respect to FIG. 5). As such, the data 406 at the secure storage 116 has stored the user identity string associated with user 105 against the first biometric data record “Bio-1” 120.

The SDK 415 can prompt (612) the user 105 to enter a biometric credential. The device 110 can capture (614) the biometric credential entered by the user 105. The device 110 can generate (616) biometric data for the biometric credential entered by the user 105.

Once the device 110 generates (616) the biometric data, the device 110 can validate (620) the generated biometric data. In some cases, validating (616) the generated biometric data of the captured biometric credential can include comparing the generated biometric data of the captured biometric credential to the biometric data records stored at the secure storage 116. To validate (618) the generated biometric data, the device 110 can determine whether the generated biometric data of the captured biometric credential and any of the biometric data records stored at the secure storage 116 are sufficiently similar to be the same person.

If the device 110 determines that there is biometric data record stored at the secure storage 116 that is sufficiently similar to the generated biometric data of the captured biometric credential of the user 105, the device 110 can identify that biometric data record and retrieve (620) the user identity string stored against the biometric data record.

For example, the device 110 can determine that the first biometric data record “Bio-1” 120 is sufficiently similar to the generated biometric data of the captured biometric credential provided by the user 105. Then, the device can retrieve (620) the user identity string associated with the user 105 stored at the secure storage 116 (e.g., “123ABC”). In some cases, once the device has validated (618) the biometric data, the device 110 can unlock the encryption key 408 and decrypt the authentication token via process 600 of FIG. 3C.

The device 110 can send (622) the authentication token and/or the user identity string to the SDK 415 (e.g., push operation). In some cases, the SDK 415 can access the authentication token and/or user identity string from the device 110 (e.g., pull operation).

The SDK 415 can send (624) an authentication request to the application server 420. The authentication request can request access to a particular account at the application server 420. The authentication request can include the authentication token and user identity string associated with the user 105. The authentication token can include an indicator that biometric credential entered by the user 105 was validated by the device 110.

The application server 420 can validate (626) the authentication request. Validating (626) the authentication request can include validating the authentication token and determining whether the user identity string corresponds to a particular account at the application server 420.

The application server 420 can return (628) a result to the SDK 415 based on the outcome of the validation (626) of the authentication request.

Indeed, the application server 420 can perform process 700 to validate an authentication request during biometric identity authentication. During the validation process 700, the application server 420 determines the validity of the authentication token and determines whether or not the user identity string included in the authentication request corresponds to the particular account associated with the authentication token.

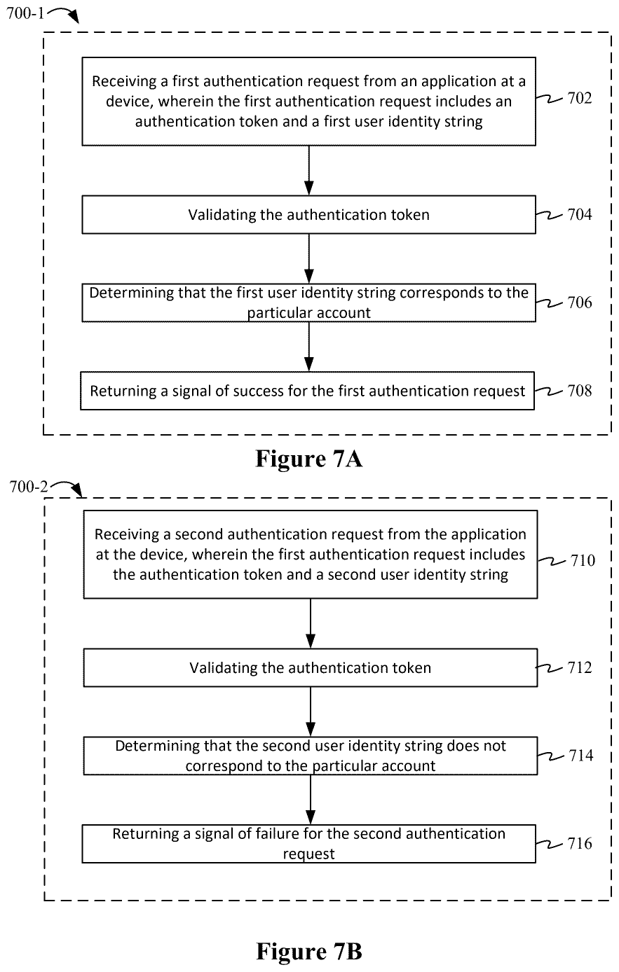

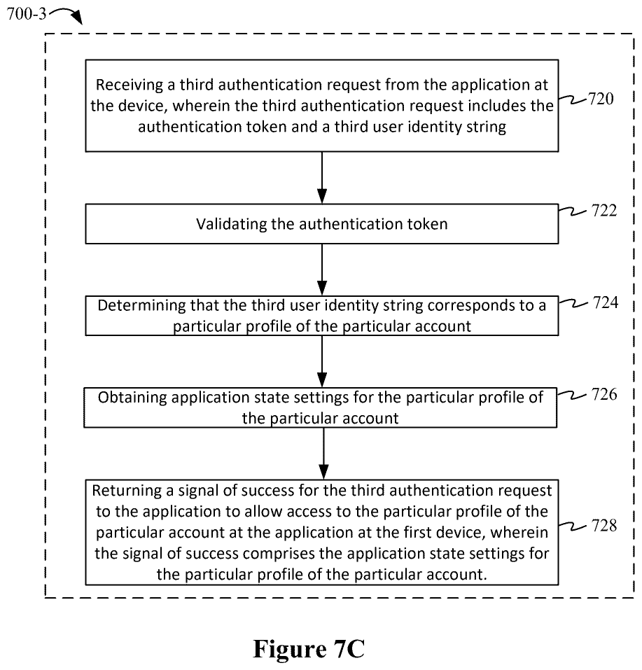

Process 700 can be implemented in a plurality of ways, including implementation 700-1 described with respect to FIG. 7A, implementation 700-2 described with respect to FIG. 7B, and implementation 700-3 described with respect to FIG. 7C.

FIGS. 7A-7C illustrate example implementations of a process of validating an authentication request during biometric identity authentication. FIG. 6B illustrates an example graphical user interface for a result of success for biometric identity authentication at an application. FIG. 6C illustrates an example graphical user interface for a result of failure for biometric identity authentication at an application; and FIG. 6D illustrates an example graphical user interface for a result of success for biometric identity authentication for a particular profile at an application.

Referring to FIG. 7A, implementation 700-1 of process 700 can include receiving (702), at an application server, an authentication request from an application at a device, wherein the authentication request includes an authentication token and a user identity string; validating (704) the authentication token; determining (706) that the user identity string corresponds to the particular account; and returning (708) a signal of success for the authentication request.

Referring to FIG. 7B, implementation 700-2 of process 700 can include receiving (710), at an application server, an authentication request from the application at the device, wherein the authentication request includes the authentication token and a user identity string; validating (712) the authentication token; determining (714) that the user identity string does not correspond to the particular account; and returning (708) a signal of failure for the authentication request.

Referring to FIG. 7C, implementation 700-3 of process 700 can include receiving (720), at an application server, an authentication request from the application at the device, wherein the authentication request includes the authentication token and a user identity string; validating (722) the authentication token received in the authentication request; determining (724) that the user identity string corresponds to a particular profile of the particular account; obtaining (726) application state settings for the particular profile of the particular account, and returning (728) a signal of success for the authentication request to the application to allow access to the particular profile of the particular account at the application at the first device, wherein the signal of success comprises the application state settings for the particular profile of the particular account.

Referring to FIG. 6A, FIG. 6B, and FIG. 7A, if the validation implementation is successful (e.g., as described with respect to FIG. 7A), the SDK 415 may allow access to the application 410, as shown in application GUI 602 of FIG. 6B. If the validation implementation is unsuccessful (e.g., as described with respect to FIG. 7B), the SDK 415 may deny access to the application 410, as shown in application GUI 604 of FIG. 6C. If the validation implementation includes particular application state settings for a particular profile of the particular account (e.g., as described with respect to FIG. 7B), the SDK 415 may display particular application state settings, as shown in application GUI 606 of FIG. 6D.

Referring to FIG. 4, FIGS. 6A-6B, and FIG. 7A, the following is an example use case of implementation 700-1 of process 700. For this example use case, the first user identity string is the first user identity string associated with user 105 and described with respect to FIG. 5 and FIG. 6A. Additionally, the authentication token can be an authentication token associated with a particular account at the application server 420 associated with user 105 and which is stored at secure storage 116 of device 110.

In response to receiving (702) a first authentication request from the application 410 at device 110, the application server 420 can validate (704) the first authentication request.

The first authentication request includes the authentication token and the first user identity string. The authentication token can include information regarding particular account associated with the user. The authentication token can also include an indicator that a biometric credential entered at the device 110 was validated by the device 110.

Validating (704) the authentication token can include performing a method of token validation. For example, a method of token validation can include decoding the authentication token, parsing the properties, and performance further queries to validate the credentials. Validating (704) the authentication token can include determining that the authentication token includes an indicator that the biometric credential entered at the device 110 was validated by the device 110.

In addition to validating (704) the authentication token, the application server 420 can determine whether the first user identity string included in the first authentication request corresponds to the particular account. Indeed, during the biometric identity authentication enrollment process 500, the application server 420 stored the first user identity string associated with the user 105 against the particular account at the application server database 425.

Determining (706) that the first user identity string corresponds to the particular account can include querying the application server database 425 for the first user identity string and verifying that the first user identity string is associated with the particular account at the application server.

In this case, because user 105 enrolled the first user identity string with the application server 420 via process 500 described with respect to FIG. 5, the application server 420 can determine (706) that the first user identity string corresponds to the particular account.

Based on the validity of the authentication token and that the first user identity string corresponds to the particular account, the application server 420 can return (708) a signal of success for the authentication request (e.g., return result (628)). In some cases, returning (708) a signal of success can result in access to the application 410, as shown in application GUI 602 of FIG. 6B.

Referring to FIG. 4, FIG. 6A, FIG. 6C, and FIG. 7B, the following is an example use case of implementation 700-2 of process 700. For this example use case, assume that the second user identity string is associated with second user 205. In some cases, the second user identity string can be null (e.g., empty field because no user identity string associated with a particular biometric credential is stored at secure storage 116). The authentication token can be the same authentication token associated with a particular account at the application server 420 associated with user 105 and which is stored at secure storage 116 of device 110.

In response to receiving (710) a second authentication request from the application 410 at device 110, the application server 420 can validate (712) the second authentication token received in the second authentication request.

The second authentication request includes the authentication token and the second user identity string. The authentication token can include information regarding the particular account associated with the user (e.g., user 105's account, since user 105 has enrolled in biometric identity authentication at the application 410).

The authentication token can also include an indicator that a biometric credential entered at the device 110 was validated by the device 110. In this example scenario, because the second user 205 has entered the biometric credential corresponding to the biometric data record “Bio-2” 220 stored at secure storage 116 of device 110, the second user 205 would successfully pass validation (e.g., validation (618) of biometric data) to enable the second user 205 to access the authentication token.

Validating (712) the authentication token can include performing a method of token validation. For example, a method of token validation can include decoding the authentication token, parsing the properties, and performance further queries to validate the credentials. Validating (712) the authentication token can include determining that the authentication token includes an indicator that the biometric credential entered at the device 110 was validated by the device 110.

In addition to validating (712) the authentication token, the application server 420 can determine whether the second user identity string corresponds to the particular account. However, in this use case, the second user 205 has not enrolled for biometric identity authentication with the application server 420. Therefore, the application server database 425 has no record of the second user identity string.

As such, determining (714) that the second user identity string does not correspond to the particular account can include querying the application server database 425 for the second user identity string and determining that the second user identity string is not associated with the particular account. In some cases, determining that the second user identity string is not associated with the particular account can include determining that the second user identity string does not exist at the application server database 425. In some cases, determining that the second user identity string is not associated with the particular account can include determining that the second user identity string exists at the application server database 425, but is associated with a different account.

In this case, because second user 205 has not enrolled the second user identity string with the application server 420 via process 500 described with respect to FIG. 5, the application server 420 can determine (714) that the second user identity string does not correspond to the particular account.

Based on the determination that the second user identity string does not correspond to the particular account, the application server 420 can return (716) a signal of failure for the authentication request (e.g., return result (628)). In some cases, returning (716) a signal of failure can result in denial of access to the application 410, as shown in application GUI 604 of FIG. 6C.

Both application GUI 602 and application GUI 604 are the result the validation process 700 for an authentication request during biometric identity authentication for the same account (e.g., the particular account associated with user 105). However, because only user 105 has enrolled in biometric identity authentication at the application 410, only the user 105 is able to access the application 410.

This is in contrast to the biometric authentication process described with respect to FIG. 3C, where even if the second user 205 never enrolled in biometric authentication with the application 305, the second user 205 could still access the application 305 using a biometric credential associated with a biometric data record stored at the secure storage 116 of the device 110.

Advantageously, using biometric identity authentication, the application server 420 can validate the authentication token and confirm that a biometric credential was successfully validated by the device 110, but can also determine whether the identity of a user attempting access at the application 410 on the device 110 corresponds to an identity of the user permitted to use the application 410.

Furthermore, in some cases, the application server 420 can store a plurality of profiles for a particular account, where each of the plurality of profiles is associated with a unique user identity string.

For example, the user 105 may share a bank account at application 410 with their partner (not shown). In this case, the user 105 may have access to full account details (e.g., as shown in application GUI 602 of FIG. 6B). As such, when the application server 420 receives the first user identity string associated with the user 105, the application server 420 can return a signal of success allowing full access to the particular profile.

However, the partner (not shown), may have enrolled a different user identity string for a particular profile of the same particular account (e.g., third user identity string).

Referring to FIG. 4, FIG. 6A, FIG. 6D, and FIG. 7C, the following is an example use case of implementation 700-3 of process 700. For this example use case, assume that the third user identity string is a user identity string associated with the partner of user 105 and which has been registered for a particular profile at the particular account associated with the user 105. Furthermore, assume that the secure storage 116 is also storing a biometric data record associated with a biometric credential of the partner (not shown). Additionally, the authentication token is the same authentication token associated with a particular account at the application server 420 associated with user 105 and which is stored at secure storage 116 of device 110.

In response to receiving (720) the third authentication request from the application 410 at device 110, the application server 420 can validate (722) the third authentication token received in the third authentication request.

The third authentication request includes the authentication token and the third user identity string. The authentication token can include information regarding the particular account associated with the user (e.g., user 105's account, since user 105 has enrolled in biometric identity authentication at the application 410).

The authentication token can also include an indicator that a biometric credential entered at the device 110 was validated by the device 110. In this case, assume that the partner has entered a biometric credential corresponding to a biometric data record stored at secure storage 116 of device 110 (not shown).

Validating (722) the authentication token can include performing a method of token validation. For example, a method of token validation can include decoding the authentication token, parsing the properties, and performance further queries to validate the credentials. Validating (722) the authentication token can include determining that the authentication token includes an indicator that the biometric credential entered at the device 110 was validated by the device 110.

In addition to validating (722) the authentication token, the application server 420 can determine whether the third user identity string corresponds to the particular account. In this case, determining whether the third user identity string corresponds to the particular account includes determining (724) that the third user identity string corresponds to a particular profile of the particular account.

Indeed, determining (724) that the third user identity string corresponds to a particular profile of the particular account can include querying the application server database 425 for the third user identity string, verifying that the third user identity string is associated with the particular account at the application server 420, and determining that the third user identity string corresponds to a particular profile of the particular account.

In response to determining (724) that the third user identity string corresponds to a particular profile of the particular account, the application server 420 can obtain (726) application state settings for the particular profile of the particular account. For example, the application state settings may include, but are not limited to, different access permissions, different GUI layout settings, a particular sub-profile of a particular account, and session data.

Based on the validity of the authentication token and that the third user identity string corresponds to a particular profile of the particular account, the application server 420 can return (728) a signal of success for the third authentication request (e.g., return result (628)) to allow access to the particular profile of the particular account at the application 410 of the device 110, as shown in application GUI 606 of FIG. 6D. Indeed, the signal of success can include application state settings for the particular profile of the particular account.

Both application GUI 602 and application GUI 606 are the result the validation process 700 for an authentication request during biometric identity authentication for the same account (e.g., the particular account associated with user 105). However, because the first authentication request included the first user identity string associated with the user 105 and the third authentication request included the third user identity string associated with the partner (not shown), the application server 420 was able to distinguish between the identities of the user attempting to log in via biometric identity authentication and provide a validation result accordingly.

FIG. 8 illustrates an example process for registration at a biometric service provider. Referring to FIG. 4 and FIG. 8, via process 800, a user 105 can register at the biometric service provider 430. Process 800 can start when a user 105 requests (802) to register at the biometric service provider 430. For example, the user 105 may request (802) to register at a website or application associated with the biometric service provider 430 (e.g., via device 110). In some cases, the user 105 may request (802) to register with the biometric service provider 430 at a physical location associated with the biometric service provider 430.

The biometric service provider 430 can send (804) a prompt for user identity information. The user identity information can include a first name, a last name, government issued identification or other demographic data associated with the user. The user 105 can provide user identity information by providing proof of identity (e.g., driver's license, social security number (SSN)/SSN card, passport government issued identification, etc.). For example, the user 105 may upload a picture of government issued identification card as proof of identity.

In some cases, the biometric service provider 430 can verify the user identity information provided (806) by the user. For example, the biometric service provider 430 may have access to a database of information associated with government issued identification.

The biometric service provider 430 can send (808) a prompt for the user 105 to enter a biometric credential.

The user 105 can send (810) a biometric data of a biometric credential to the biometric service provider 430. In some cases, the user 105 can send (810) the biometric data of the biometric credential via device 110 (e.g., face scan via camera 102, fingerprint scan via fingerprint scanner 104, etc.). In some cases, the user 105 can send (810) the biometric data of the biometric credential via a third-party biometric credential capture service.

Once the biometric service provider 430 has received both the user identity information and the biometric data of the biometric credential, the biometric service provider 430 can associate (812) the biometric data of the user 105 with user identity information of the user 105. For example, the biometric service provider 430 can generate a BioID record associating the biometric data of the user 105 to the user identity information of the user 105. The BioID record can include, but is not limited to, a first name, a last name, a biometric data string, and a user identity information string. The biometric data string can be a string of characters associated with a particular biometric data record associated with the user 105. The user identity string can be a string of characters associated with a particular user identity record associated with the user 105.

Then, the biometric service provider 430 can store (814) the BioID record associated the user 105, for example, at the biometric service database 435. The biometric service database 435 can store BioID records associated with a plurality of users.

FIG. 9A illustrates components of a computing device that may be used in certain embodiments described herein.

Referring to FIG. 9A, system 900 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to system 900 may be incorporated to implement a particular computing device. System 900 includes a processing system 905 of one or more processors to transform or manipulate data according to the instructions of software stored on a storage system 915. Examples of processors of the processing system 905 include general purpose central processing units, application specific processors, and logic devices, as well as any other type of processing device, combinations, or variations thereof. The processing system 905 may be, or is included in, a system-on-chip (SoC) along with one or more other components such as network connectivity components, sensors, video display components.

The storage system 915 can include an operating system 918 and application programs such as application 305 and associated SDK 315 and application 410 and associated SDK 415 described herein. Device operating systems 918 generally control and coordinate the functions of the various components in the computing device, providing an easier way for applications to connect with lower level interfaces like the networking interface.

Storage system 915 may comprise any computer readable storage media readable by the processing system 905 and capable of storing software including the application 305 and application 410. Storage system 915 may include volatile and nonvolatile memories, removable and non-removable media implemented in any method or technology for storage of information, such as computer readable instructions, data structures, program modules, or other data. Examples of storage media of storage system 915 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 915 may be implemented as a single storage device but may also be implemented across multiple storage devices or sub-systems co-located or distributed relative to each other. Storage system 915 may include additional elements, such as a controller, capable of communicating with processing system 905.

Software at the storage system 915 may be implemented in program instructions and among other functions may, when executed by system 900 in general or processing system 905 in particular, direct system 900 or the one or more processors of processing system 905 to operate as described herein.

The system can further include user interface system 930, which may include input/output (I/O) devices and components that enable communication between a user and the system 900. User interface system 930 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 930 may also include output devices such as display screen(s), speakers, haptic devices for tactile feedback, and other types of output devices. In certain cases, the input and output devices may be combined in a single device, such as a touchscreen, or touch-sensitive, display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display (not shown) in myriad ways, presenting graphical user interface elements, text, images, video, notifications, virtual buttons, virtual keyboards, or any other type of information capable of being depicted in visual form.

The user interface system 930 may also include user interface software and associated software (e.g., for graphics chips and input devices) executed by the OS in support of the various user input and output devices. The associated software assists the OS in communicating user interface hardware events to application programs using defined mechanisms. The user interface system 930 including user interface software may support a graphical user interface, a natural user interface, or any other type of user interface. For example, the user interfaces for application 305 and/or application 410 as described herein may be presented through user interface system 930.

Network interface 940 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 918, which informs applications of communications events when necessary.

FIG. 9B illustrates components of a computing device that may be used in certain embodiments described herein.

Referring to FIG. 9B, system 950 can include one or more blade server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 950 can include a processing system 955, which may include one or more processors and/or other circuitry that retrieves and executes software from the storage system 965.

The processing system 955 may be implemented within a single processing device but may also be distributed across multiple processing devices or sub-systems that cooperate in executing program instructions.

The storage system 965 can include an operating system 970 and software for executing various implementations of process 700 described herein. Device operating systems 970 generally control and coordinate the functions of the various components in the computing device, providing an easier way for applications to connect with lower level interfaces like the networking interface.

Storage system 965 may include any computer readable storage media readable by the processing system 955 and capable of storing software including instructions for process 700. Storage system 965 may include volatile and nonvolatile memories, removable and non-removable media implemented in any method or technology for storage of information, such as computer readable instructions, data structures, program modules, or other data. Examples of storage media of storage system 965 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 965 may be implemented as a single storage device but may also be implemented across multiple storage devices or sub-systems co-located or distributed relative to each other. Storage system 965 may include additional elements, such as a controller, capable of communicating with processing system 955. The storage system 965 may also include storage devices and/or sub-systems on which data is stored. System 950 may access one or more storage resources in order to access information to carry out any of the processes (e.g., process 700) indicated by software.

Software at the storage system 965 may be implemented in program instructions and among other functions may, when executed by system 950 in general or processing system 955 in particular, direct system 950 or the one or more processors of processing system 955 to operate as described herein.

Network interface 980 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 970, which informs applications of communications events when necessary.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method, comprising:
receiving, at an application server, a first authentication request from an application at a first device, wherein the first authentication request comprises an authentication token requesting access to a particular account at the application server and a first user identity string associated with a first user, wherein the authentication token comprises an indicator confirming that a biometric credential was validated by the first device;
validating, at the application server, the authentication token, wherein validating the authentication token comprises determining, by the application server, that the authentication token includes the indicator that the biometric credential entered at the first device was validated by the first device;
determining, at the application server, that the first user identity string corresponds to the particular account;
based on the validity of the authentication token and that the first user identity string corresponds to the particular account, returning a signal of success for the first authentication request to the application to allow access to the particular account at the application at the first device;
receiving, at the application server, a second authentication request from the application at the first device, wherein the second authentication request comprises the authentication token requesting access to the particular account at the application server and a second user identity string associated with a second user;
validating, at the application server, the authentication token received with the second authentication request, wherein validating the authentication token comprises determining, by the application server, that the authentication token includes the indicator that the biometric credential entered at the first device was validated by the first device;
determining, at the application server, that the second user identity string does not correspond to the particular account; and
based on the determination that the second user identity string does not correspond to the particular account, returning a signal of failure for the second authentication request to the application to deny access to the particular account at the application at the first device.

2. The method of claim 1, further comprising:
receiving, at the application server, a third authentication request from an application at the first device, wherein the first authentication request comprises the authentication token and a third user identity string;
validating, at the application server, the authentication token received with the third authentication request;
determining, at the application server, that the third user identity string corresponds to a particular profile of the particular account;
obtaining, at the application server, application state settings for the particular profile of the particular account; and
based on the validity of the authentication token and that the third user identity string corresponds to a particular profile of the particular account, returning a signal of success for the first authentication request to the application to allow access to the particular profile of the particular account at the application at the first device, wherein the signal of success comprises the application state settings for the particular profile of the particular account.

3. The method of claim 1, wherein determining, at the application server, that the first user identity string corresponds to the particular account comprises:
querying an application server database for the first user identity string; and
verifying that the first user identity string is associated with the particular account at the application server.

4. The method of claim 1, further comprising:
receiving, at the application server from the application at the first device, a request for user authentication;
sending, to the application at the first device, a prompt for an authentication credential;
receiving, at the application server from the application at the first device, an authentication credential associated with the particular account;
validating, at the application server, the authentication credential; and
returning, to the first device, the authentication token.

5. The method of claim 1, further comprising:
receiving, at the application server from the application at the first device, a request to enroll the particular account in biometric identity authentication at the application, wherein the request comprises encrypted biometric data corresponding to a biometric credential of the first user;
forwarding the encrypted biometric data to a biometric service provider for user identity validation;
receiving, at the application server from the biometric service provider, a biometric identity (BioID) token comprising user identity information and the user identity string associated with the first user; and
storing, at an application server database, the user identity string associated with the first user against the particular account.

6. The method of claim 5, wherein the user identity information comprises a first name of the first user and a last name of the user, and wherein the user identity string associated with the first user comprises a unique string of characters.

7. The method of claim 5, wherein the BioID token comprises a signed JSON Web Token.

8. A system comprising:
a processing system;
one or more storage media; and
instructions stored on the one or more storage media that, when executed by the processing system, direct the processing system to at least:
receive, at an application server, a first authentication request from an application at a first device, wherein the first authentication request comprises an authentication token requesting access to a particular account at the application server and a first user identity string associated with a first user, wherein the authentication token comprises an indicator confirming that a biometric credential was validated by the first device;
validate, at the application server, the authentication token, wherein the instructions to validate the authentication token direct the processing system to determine, by the application server, that the authentication token includes the indicator that the biometric credential entered at the first device was validated by the first device;
determine, at the application server, that the first user identity string corresponds to the particular account;
based on the validity of the authentication token and that the first user identity string corresponds to the particular account, return a signal of success for the first authentication request to the application to allow access to the particular account at the application at the first device;
receive, at the application server, a second authentication request from the application at the first device, wherein the second authentication request comprises the authentication token requesting access to the particular account at the application server and a second user identity string associated with a second user;
validate, at the application server, the authentication token received with the second authentication request, wherein the instructions to validate the authentication token direct the processing system to determine, by the application server, that the authentication token includes the indicator that the biometric credential entered at the first device was validated by the first device;
determine, at the application server, that the second user identity string does not correspond to the particular account; and
based on the determination that the second user identity string does not correspond to the particular account, return a signal of failure for the second authentication request to the application to deny access to the particular account at the application at the first device.

9. The system of claim 8, wherein the instructions further direct the processing system to:
receive, at the application server, a third authentication request from an application at the first device, wherein the first authentication request comprises the authentication token and a third user identity string;
validate, at the application server, the authentication token received with the third authentication request;
determine, at the application server, that the third user identity string corresponds to a particular profile of the particular account;
obtain, at the application server, application state settings for the particular profile of the particular account; and
based on the validity of the authentication token and that the third user identity string corresponds to a particular profile of the particular account, return a signal of success for the first authentication request to the application to allow access to the particular profile of the particular account at the application at the first device, wherein the signal of success comprises the application state settings for the particular profile of the particular account.

10. The system of claim 8, wherein the instructions to determine, at the application server, that the first user identity string corresponds to the particular account further direct the processing system to:
query an application server database for the first user identity string; and
verify that the first user identity string is associated with the particular account at the application server.

11. The system of claim 8, wherein the instructions further direct the processing system to:
receive, at the application server from the application at the first device, a request for user authentication;
send, to the application at the first device, a prompt for an authentication credential;
receive, at the application server from the application at the first device, an authentication credential associated with the particular account;
validate, at the application server, the authentication credential; and
return, to the first device, the authentication token.

12. The system of claim 8, wherein the instructions further direct the processing system to:
receive, at the application server from the application at the first device, a request to enroll the particular account in biometric identity authentication at the application, wherein the request comprises encrypted biometric data corresponding to a biometric credential of the first user;
forward the encrypted biometric data to a biometric service provider for user identity validation;
receive, at the application server from the biometric service provider, a biometric identity (BioID) token comprising user identity information and the user identity string associated with the first user; and
store, at an application server database, the user identity string associated with the first user against the particular account.

13. The system of claim 12, wherein the user identity information comprises a first name of the first user and a last name of the user, and wherein the user identity string associated with the first user comprises a unique string of characters.

14. (canceled)

15. A computer readable storage medium having instructions of an application server stored thereon that when executed by a computing system, direct the computing system to at least:
receive, at the application server, a first authentication request from an application at a first device, wherein the first authentication request comprises an authentication token requesting access to a particular account at the application server and a first user identity string associated with a first user, wherein the authentication token comprises an indicator confirming that a biometric credential was validated by the first device;
validate, at the application server, the authentication token, wherein the instructions to validate the authentication token direct the computing system to determine, by the application server, that the authentication token includes the indicator that the biometric credential entered at the first device was validated by the first device;
determine, at the application server, that the first user identity string corresponds to the particular account;
based on the validity of the authentication token and that the first user identity string corresponds to the particular account, return a signal of success for the first authentication request to the application to allow access to the particular account at the application at the first device;
receive, at the application server, a second authentication request from the application at the first device, wherein the second authentication request comprises the authentication token requesting access to the particular account at the application server and a second user identity string associated with a second user;
validate, at the application server, the authentication token received with the second authentication request, wherein the instructions to validate the authentication token direct the computing system to determine, by the application server, that the authentication token includes the indicator that the biometric credential entered at the first device was validated by the first device;
determine, at the application server, that the second user identity string does not correspond to the particular account; and
based on the determination that the second user identity string does not correspond to the particular account, return a signal of failure for the second authentication request to the application to deny access to the particular account at the application at the first device.

16. The computer readable storage medium of claim 15, wherein the instructions further direct the computing system to:
receive, at the application server, a third authentication request from an application at the first device, wherein the first authentication request comprises the authentication token and a third user identity string;
validate, at the application server, the authentication token received with the third authentication request;
determine, at the application server, that the third user identity string corresponds to a particular profile of the particular account;
obtain, at the application server, application state settings for the particular profile of the particular account; and
based on the validity of the authentication token and that the third user identity string corresponds to a particular profile of the particular account, return a signal of success for the first authentication request to the application to allow access to the particular profile of the particular account at the application at the first device, wherein the signal of success comprises the application state settings for the particular profile of the particular account.

17. The computer readable storage medium of claim 15, wherein the instructions to determine, at the application server, that the first user identity string corresponds to the particular account further direct the computing system to:
query an application server database for the first user identity string; and
verify that the first user identity string is associated with the particular account at the application server.

18. The computer readable storage medium of claim 15, wherein the instructions further direct the computing system to:
receive, at the application server from the application at the first device, a request for user authentication;
send, to the application at the first device, a prompt for an authentication credential;
receive, at the application server from the application at the first device, an authentication credential associated with the particular account;
validate, at the application server, the authentication credential; and
return, to the first device, the authentication token.

19. The computer readable storage medium of claim 15, wherein the instructions further direct the computing system to:
receive, at the application server from the application at the first device, a request to enroll the particular account in biometric identity authentication at the application, wherein the request comprises encrypted biometric data corresponding to a biometric credential of the first user;
forward the encrypted biometric data to a biometric service provider for user identity validation;
receive, at the application server from the biometric service provider, a biometric identity (BioID) token comprising user identity information and the user identity string associated with the first user; and
store, at an application server database, the user identity string associated with the first user against the particular account.

20. The computer readable storage medium of claim 19, wherein the user identity information comprises a first name of the first user and a last name of the user, and wherein the user identity string associated with the first user comprises a unique string of characters.

21. The method of claim 1, wherein the first authentication request does not include biometric data, wherein the biometric data is stored in a trusted execution environment of the first device.
